(19) United States
(12) Patent Application Publication
(10) Pub. No.: US 2011/0208666 A1
(43) Pub. Date: Aug. 25, 2011

(54) BUSINESS DRIVEN TRAINING AND QUALIFICATIONS SYSTEM

(75) Inventors: Ramez Labib Akhnoukh, Neuilly Sur Seine (FR); Kamaljeet Singh, Livingston (GB); Andrew Thomas Kernan, Copthorne (GB)

(73) Assignee: SCHLUMBERGER TECHNOLOGY CORPORATION, Sugar Land, TX (US)

(21) Appl. No.: 12/861,160

(22) Filed: Aug. 23, 2010

Related U.S. Application Data
(60) Provisional application No. 61/240,175, filed on Sep. 4, 2009.

(51) Int. Cl. G06Q 50/00

(52) U.S. Cl. 705/328

(57) ABSTRACT

A method for business driven training includes obtaining a vocational profile for a user, where the vocational profile includes a vocational type for the user; obtaining training information for the user using the vocational type, where the training information includes assessments and completed training of the user; and determining a training program for the user based on the training information, where the training program specifies required training courses to obtain a promotion certification for the user. The method further includes generating a qualifications profile based on the training information, where the qualification profile specifies services that the user is capable of providing, and displaying the qualifications profile and a progress of the user in the training program, where the qualification profile includes a proficiency for each of the services that the user is capable of providing.

### CROSS-REFERENCE TO RELATED APPLICATION

This application claims priority, pursuant to 35 U.S.C. §119(e), to the filing date of U.S. Patent Application Ser. No. 61/240,175, entitled “Business Driven Training and Qualifications System,” filed on Sep. 4, 2009, with Attorney Docket No. 10.0068; 09469/177001, which is hereby incorporated by reference in its entirety.

### BACKGROUND

Current training systems for different training programs vary considerably from huge complex data entry structures to little more than a way to record classes attended and links to external sites that held their previous training programs. The complex structures are typically designed to require users to enter large amounts of information to track their progress in training. Further, the complex structures typically lack a consistent implementation in each training program, requiring frequent modifications and software updates to be compatible with updated training regimens.

Typical training software is used to track a person's progression for qualification for promotion to the next promotion level or position within an organization, where selection of learning items results in a qualification for promotion for the person. In this case, the person is only motivated to record their training information when a promotion will result from the data entry, which causes the information to be outdated until the promotion occurs. Further, typical training software does not implement universal rules and conventions, resulting in unstructured data objects that can be difficult to search and use.

### SUMMARY

In one or more implementations of steering a drilling operation of a well using acoustic measurements, the method includes obtaining, using a central processing unit (CPU), a clean-wet matrix line for the well, where the clean-wet matrix line includes a number of normal compressional values, obtaining, using the CPU, the acoustic measurements from at least one logging while drilling tool at a current depth of the drilling operation, where the acoustic measurements include a compressional to shear velocity ratio and a delta-T compressional measurement, and determining, using the CPU, a current phase of the drilling operation by comparing the acoustic measurements to the clean-wet matrix line. The method further includes, in response to determining that the current phase is not a target phase, generating an updated well trajectory for steering the drilling operation toward the target phase and adjusting the drilling operation using the updated well trajectory.

Other aspects of business driven training and qualifications system will be apparent from the following description and the appended claims.

### BRIEF DESCRIPTION OF DRAWINGS

It is to be noted that the appended drawings illustrate only typical embodiments and are therefore not to be considered limiting of the scope of business driven training and qualifications, which may admit to other equally effective embodiments.

FIGS. 1.1-1.4 depict a simplified, schematic view of an oilfield having subterranean formations containing reservoirs therein, the various oilfield operations being performed on the oilfield.

FIG. 2 is a schematic view, partially in cross section of an oilfield having a plurality of data acquisition tools positioned at various locations along the oilfield for collecting data from the subterranean formations.

FIG. 3 show example schematic diagrams of a system for performing training, as exemplified by training for oilfield operations.

FIGS. 4-5 show example flow charts depicting methods for performing training, as exemplified by training for oilfield operations.

FIG. 6 shows an example certification in accordance with one or more embodiments.

FIG. 7 shows an illustrative computer system on which implementations of various techniques described herein may be implemented in accordance with one or more embodiments.

### DESCRIPTION

Specific embodiments of business driven training and qualifications will now be described in detail with reference to the accompanying figures. Like elements in the various figures are denoted by like reference numerals for consistency.

In the following detailed description of embodiments of business driven training and qualifications, numerous specific details are set forth in order to provide a more thorough understanding of business driven training and qualifications. In other instances, well-known features have not been described in detail to avoid obscuring the described embodiments.

The embodiments of business driven training and qualifications provide a system and a method for performing oilfield training. Embodiments of business driven training and qualifications also provide at least a method and system for (i) generating qualifications profiles for a user; and (ii) using the qualification profiles to generate a plan for carrying out certain operations at a business site. For example, generation of a plan for performing oilfield operations at a wellsite. Accordingly, we provide a general description of figures related to an oilfield for context and reference. Of course, the general principles described herein could be applied to other types of businesses or operations.

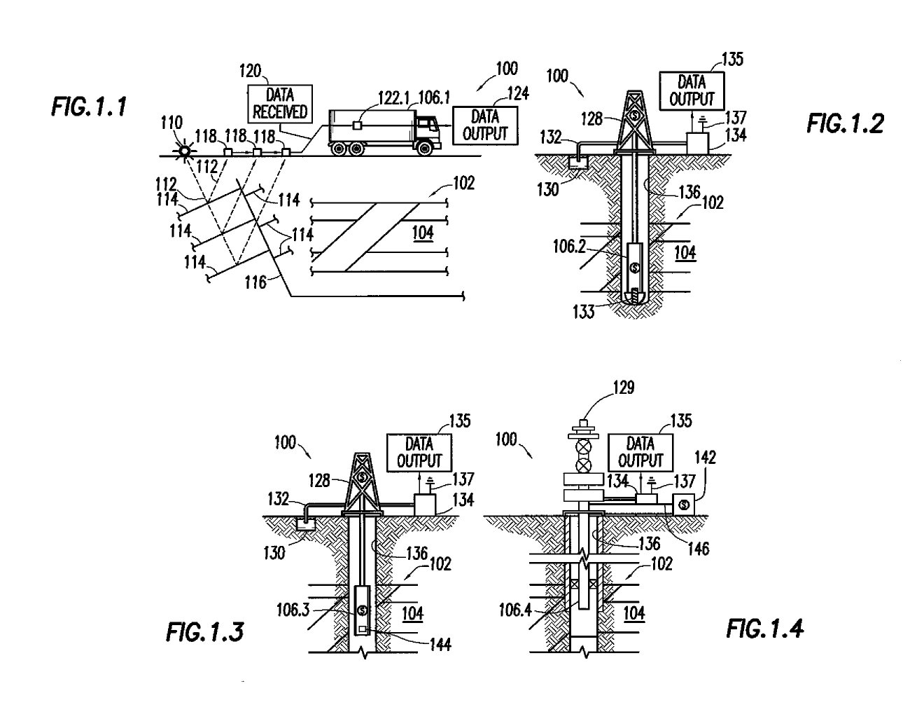

FIGS. 1.1-1.4 depict simplified, representative, schematic views of an oilfield 100 having subterranean formation 102 containing reservoir 104 therein and depicting various oilfield operations being performed on the oilfield 100. FIG. 1.1 depicts a survey operation being performed by a survey tool, such as seismic truck 106.1, to measure properties of the subterranean formation. The survey operation is a seismic survey operation for producing sound vibrations. In FIG. 1.1, one such sound vibration 112 generated by a source 110 reflects off a plurality of horizons 114 in an earth formation 116. The sound vibration(s) 112 is are received in by sensors, such as geophone-receivers 118, situated on the earth's surface, and the geophones 118 produce electrical output signals, referred to as data received 120 in FIG. 1.1.

In response to the received sound vibration(s) 112 representative of different parameters (such as amplitude and/or frequency) of the sound vibration(s) 112, the geophones 118 produce electrical output signals containing data concerning the subterranean formation. The data received 120 is provided as input data to a computer 122.1 of the seismic truck 106.1, and responsive to the input data, the computer 122.1 generates a seismic data output 124. The seismic data output may be stored, transmitted or further processed as desired, for example by data reduction.

FIG. 1.2 depicts a drilling operation being performed by drilling tools 106.2 suspended by a rig 128 and advanced into the subterranean formations 102 to form a wellbore 136. A mud pit 130 is used to draw drilling mud into the drilling tools via flow line 132 for circulating drilling mud through the drilling tools, up the wellbore 136 and back to the surface. The drilling mud is usually filtered and returned to the mud pit. A circulating system may be used for storing, controlling, or filtering the flowing drilling muds. The drilling tools are advanced into the subterranean formations to reach reservoir 104. Each well may target one or more reservoirs. The drilling tools are preferably adapted for measuring downhole properties using logging while drilling tools. The logging while drilling tool may also be adapted for taking a core sample 133 as shown, or removed so that a core sample may be taken using another tool.

A surface unit 134 is used to communicate with the drilling tools and/or offsite operations. The surface unit 134 is capable of communicating with the drilling tools to send commands to the drilling tools, and to receive data therefrom. The surface unit 134 is preferably provided with computer facilities for receiving, storing, processing, and/or analyzing data from the oilfield 100. The surface unit 134 collects data generated during the drilling operation and produces data output 135 which may be stored or transmitted. Computer facilities, such as those of the surface unit 134, may be positioned at various locations about the oilfield 100 and/or at remote locations.

Sensors (S), such as gauges, may be positioned about the oilfield 100 to collect data relating to various oilfield operations as described previously. As shown, the sensor (S) is positioned in one or more locations in the drilling tools and/or at the rig to measure drilling parameters, such as weight on bit, torque on bit, pressures, temperatures, flow rates, compositions, rotary speed and/or other parameters of the oilfield operation. Sensors may also be positioned in one or more locations in the circulating system.

The data gathered by the sensors may be collected by the surface unit 134 and/or other data collection sources for analysis or other processing. The data collected by the sensors may be used alone or in combination with other data. The data may be collected in one or more databases and/or transmitted on or offsite. All or select portions of the data may be selectively used for analyzing and/or predicting oilfield operations of the current and/or other wellbores. The data may be may be historical data, real time data, or combinations thereof. The real time data may be used in real time, or stored for later use. The data may also be combined with historical data or other inputs for further analysis. The data may be stored in separate databases, or combined into a single database.

The collected data may be used to perform analysis, such as modeling operations. For example, the seismic data output may be used to perform geological, geophysical, and/or reservoir engineering. The reservoir, wellbore, surface and/or process data may be used to perform reservoir, wellbore, geological, and geophysical or other simulations. The data outputs from the oilfield operation may be generated directly from the sensors, or after some preprocessing or modeling. These data outputs may act as inputs for further analysis.

The data may be collected and stored at the surface unit 134. One or more surface units may be located at the oilfield 100, or connected remotely thereto. The surface unit 134 may be a single unit, or a complex network of units used to perform the necessary data management functions throughout the oilfield 100. The surface unit 134 may be a manual or automatic system. The surface unit 134 may be operated and/or adjusted by a user.

The surface unit 134 may be provided with a transceiver 137 to allow communications between the surface unit 134 and various portions of the oilfield 100 or other locations. The surface unit 134 may also be provided with or functionally connected to one or more controllers for actuating mechanisms at the oilfield 100. The surface unit 134 may then send command signals to the oilfield 100 in response to data received. The surface unit 134 may receive commands via the transceiver or may itself execute commands to the controller. A processor may be provided to analyze the data (locally or remotely), make the decisions, and/or actuate the controller. In this manner, the oilfield 100 may be selectively adjusted based on the data collected. This technique may be used to optimize portions of the oilfield operation, such as controlling drilling, weight on bit, pump rates, or other parameters. These adjustments may be made automatically based on computer protocol, and/or manually by an operator. In some cases, well plans may be adjusted to select optimum operating conditions, or to avoid problems.

FIG. 1.3 depicts a wireline operation being performed by a wireline tool 106.3 suspended by the rig 128 and into the wellbore 136 of FIG. 1.2. The wireline tool is preferably adapted for deployment into a wellbore for generating well logs, performing downhole tests, and/or collecting samples. The wireline tool may be used to provide another method and apparatus for performing a seismic survey operation. The wireline tool of FIG. 1.3 may, for example, have an explosive, radioactive, electrical, or acoustic energy source 144 that sends and/or receives electrical signals to the surrounding subterranean formations 102 and fluids therein.

The wireline tool may be operatively connected to, for example, the geophones 118, and the computer 122.1 of the seismic truck 106.1 of FIG. 1.1. The wireline tool may also provide data to the surface unit 134. The surface unit 134 collects data generated during the wireline operation and produces data output 135 which may be stored or transmitted. The wireline tool may be positioned at various depths in the wellbore to provide a survey or other information relating to the subterranean formation.

Sensors (S), such as gauges, may be positioned about the oilfield 100 to collect data relating to various oilfield operations as described previously. As shown, the sensor (S) is positioned in the wireline tool to measure downhole parameters which relate to, for example porosity, permeability, fluid composition and/or other parameters of the oilfield operation.

FIG. 1.4 depicts a production operation being performed by a production tool 106.4 deployed from a production unit or christmas tree 129 and into the completed wellbore 136 of FIG. 1.3 for drawing fluid from the downhole reservoirs into surface facilities 142. Fluid flows from reservoir 104 through perforations in the casing (not shown) and into the production tool 106.4 in the wellbore 136 and to the surface facilities 142 via a gathering network 146.

Sensors (S), such as gauges, may be positioned about the oilfield 100 to collect data relating to various oilfield operations as described previously. As shown, the sensor (S) may be positioned in the production tool 106.4 or associated equipment, such as the christmas tree, gathering network, surface facilities and/or the production facility, to measure fluid parameters, such as fluid composition, flow rates, pressures, temperatures, and/or other parameters of the production operation.

While only simplified wellsite configurations are shown, it will be appreciated that the oilfield 100 may cover a portion of land, sea, and/or water locations that hosts one or more wellsites. Production may also include injection wells (not shown) for added recovery. One or more gathering facilities may be operatively connected to one or more of the wellsites for selectively collecting downhole fluids from the wellsite(s).

While FIGS. 1.2-1.4 depict tools used to measure properties of an oilfield, it will be appreciated that the tools may be used in connection with non-oilfield operations, such as mines, aquifers, storage, or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The oilfield configuration of FIGS. 1.1-1.4 is intended to provide a brief description of an example of an oilfield usable with business driven training and qualifications. Part, or all, of the oilfield 100 may be on land, water, and/or sea. Also, while a single oilfield measured at a single location is depicted, business driven training and qualifications may be used with any combination of one or more oilfields, one or more processing facilities, and one or more wellsites.

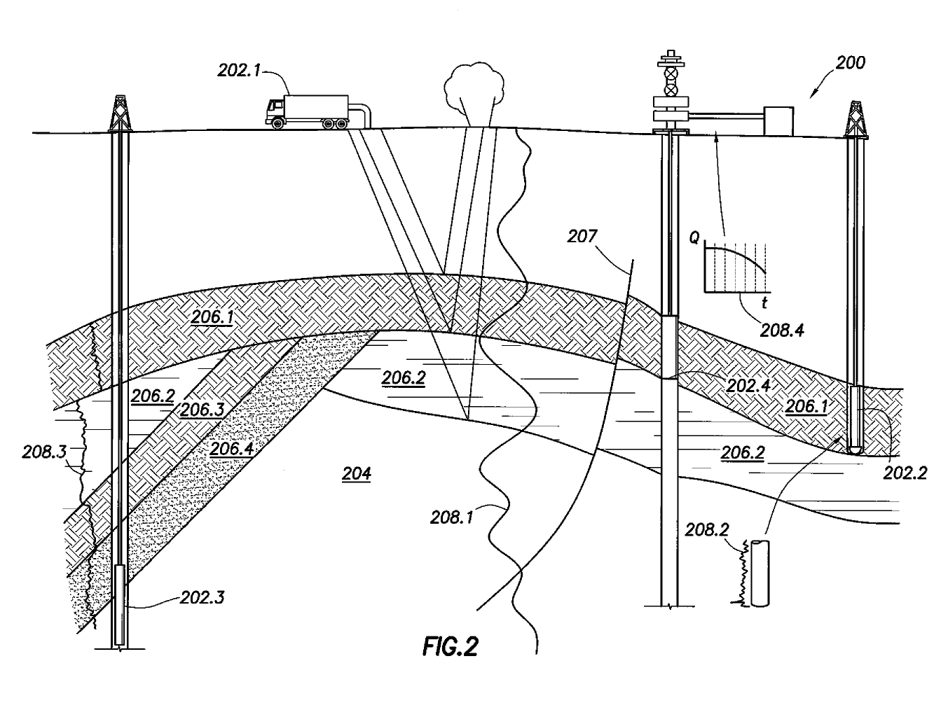

FIG. 2 is a schematic view, partially in cross section of an oilfield 200 having data acquisition tools 202.1, 202.2, 202.3 and 202.4 positioned at various locations along the oilfield 200 for collecting data of the subterranean formation 204. The data acquisition tools 202.1-202.4 may be the same as data acquisition tools 106.1-106.4 of FIGS. 1.1-1.4, respectively, or others not depicted. As shown, the data acquisition tools 202.1-202.4 generate data plots or measurements 208.1-202.4, respectively. These data plots are depicted along the oilfield 200 to demonstrate the data generated by the various operations.

Data plots 208.1-208.3 are examples of static data plots that may be generated by the data acquisition tools 202.1-202.4, respectively. Static data plot 208.1 is a seismic two-way response time. Static plot 208.2 is core sample data measured from a core sample of the formation 204. Static data plot 208.3 is a logging trace. Production decline curve or graph 208.4 is a dynamic data plot of the fluid flow rate over time. Other data may also be collected, such as historical data, user inputs, economic information and/or other measurement data and other parameters of interest.

The subterranean structure 204 has a plurality of geological formations 206.1-d. As shown, the structure has several formations or layers, including a shale layer 206.1, a carbonate layer 206.2, a shale layer 206.3, and a sand layer 206.4. A fault 207 extends through the layers 206.1, 206.2. The static data acquisition tools are preferably adapted to take measurements and detect characteristics of the formations.

While a specific subterranean formation with specific geological structures is depicted, it will be appreciated that the oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in the oilfield 200, it will be appreciated that one or more types of measurement may be taken at one or more location across one or more oilfields or other locations for comparison and/or analysis.

The data collected from various sources, such as the data acquisition tools of FIG. 2, may then be processed and/or evaluated. Typically, seismic data displayed in the static data plot 208.1 from the data acquisition tool 202.1 is used by a geophysicist to determine characteristics of the subterranean formations and features. Core data shown in static plot 208.2 and/or log data from the well log 208.3 are typically used by a geologist to determine various characteristics of the subterranean formation. Production data from the graph 208.4 is typically used by the reservoir engineer to determine fluid flow reservoir characteristics. The data analyzed by the geologist, geophysicist and the reservoir engineer may be analyzed using modeling techniques.

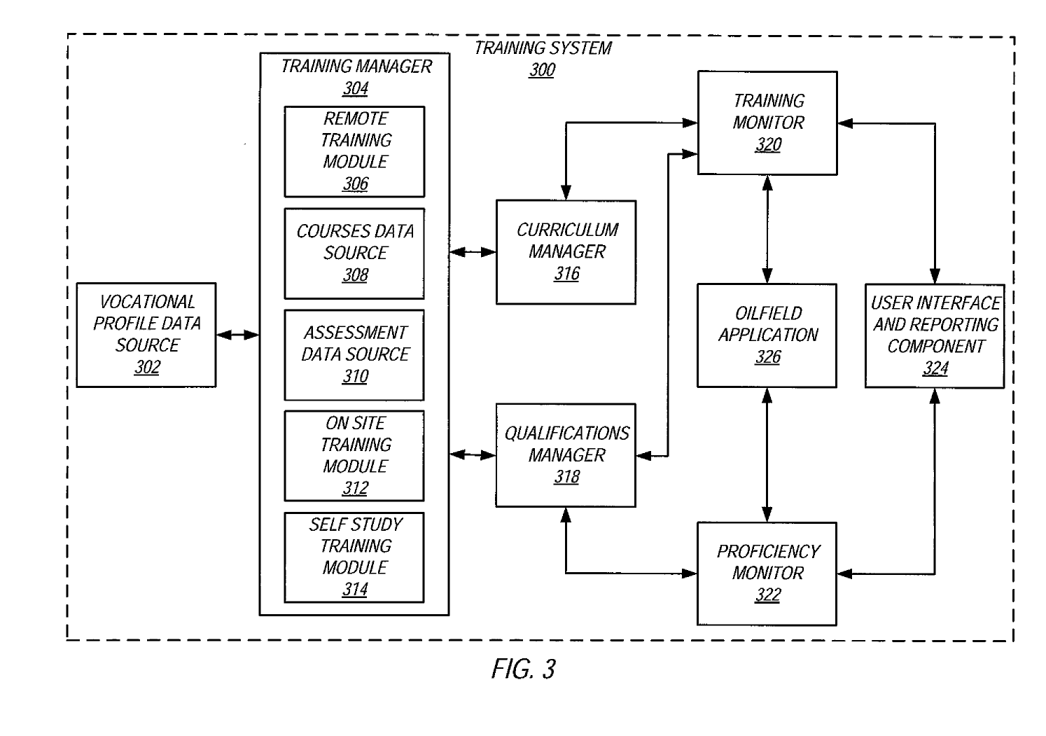

FIG. 3 is a schematic view of a system 300 for performing business-driven qualification and training. The training system may be used for training and qualifying in the oilfield or in other businesses where a qualifications-driven training and work environment is required or desired. As shown, the training system 300 includes a training manager 304 operatively connected to a vocational profile data source 302, a curriculum manager 316, and a qualifications manager 318. Also shown are a training monitor 320 interacting with the curriculum manager 316 and the qualifications manager 318 and a proficiency monitor 322 interacting with the qualifications manager 318. Further, the training system 300 includes an oilfield application 326 and a user interface and reporting component 324, each of which interact with the training monitor 320 and the proficiency monitor 322. In this case, the training manager 304 comprises a remote training module 306, a courses data source 308, an assessment data source 310, an on site training module 312, and a self study training module 314.

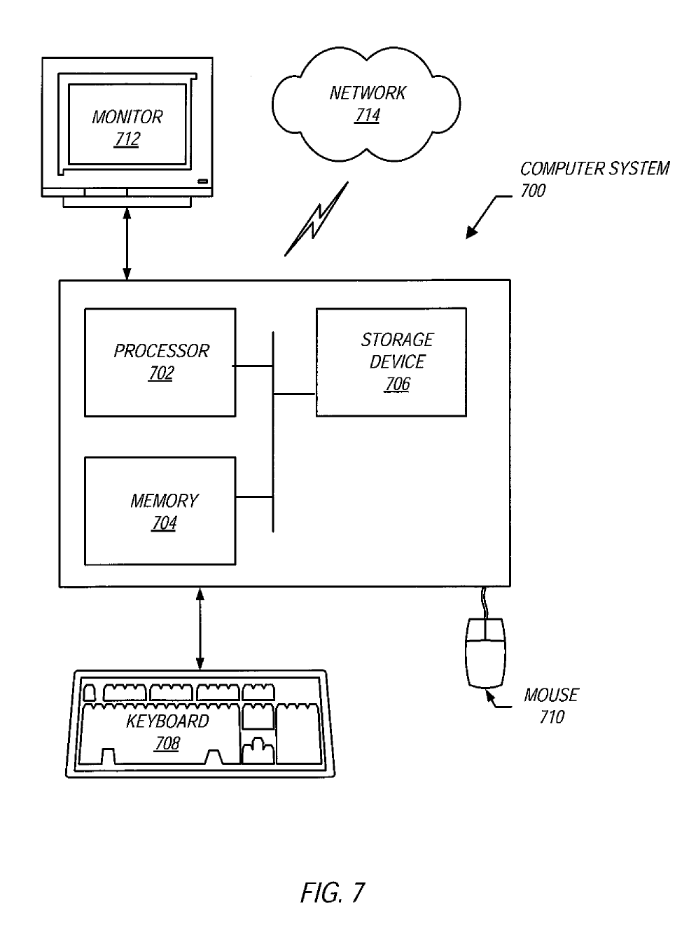

In one or more embodiments, the training system 300 corresponds to a computing system configured to manage business driven training and qualifications. For example, the training system 300 may be implemented on a computer as described below with respect to FIG. 7. In another example, the training system 300 may be implemented as a distributed system (e.g., vocational profile data source 302 implemented on a database server, training manager 304 implemented on an application server, user interface and reporting component 324 implemented as a web-based application, etc.). Those skilled in the art will appreciate that the training system 300 may be implemented over a variety of networks (e.g., a local area network (LAN), a wide area network (WAN) such as the Internet, or any other similar type of network).

In one or more embodiments, the training manager 304 is configured to manage training information for users. For example, the training manager 304 may correspond to a complete and integrated web-based training management system. In another example, the training manager 304 may correspond to an off-line system configured to periodically perform web-based synchronizations. The training manager 304 may be configured to obtain training users data (e.g., training profile, vocational type, required roles, training program, etc.) automatically from the vocational profile data source 302. Further, the courses data source 308 and the assessment data source 310 may be configured to store a wide range of training content (e.g., user assessments, training courses, etc.).

In one or more embodiments, the vocational profile data source 302 is configured to store vocational information of users. Examples of vocational data include, but are not limited to, vocational type, grade of the user's vocation, business segment of an organization, etc. In this case, the grade of a user may refer to the progress of the user in a training program, where the user is promoted to a new grade when specific training requirements are satisfied. The vocational data stored in the vocational profile data source 302 may be used to generate vocational profiles for the users.

In one or more embodiments, the training manager 304 is configured to manage training courses. Specifically, the training manager 304 may include training modules (e.g., remote training module 306, the on site training module 312, and the self study training module 314) configured to manage structured and defined training programs linked to content (e.g., training courses) for each vocational type. Further, the training modules (e.g., remote training module 306, the on site training module 312, and the self study training module 314) may be configured to validate and track all training completed, in progress or required for all users. In one or more embodiments, the remote training module 314 may be configured to manage web-based training courses. For example, the remote training module 314 may be configured to provide web-based training courses to the user interface and reporting component 324.

In one or more embodiments, the curriculum manager 316 is configured to use the training manager 304 to determine the required training for a user. Further, the curriculum manager 316 may be configured to monitor the progress of the user with respect to both individual training items and overall progress of the steps required to obtain a promotion certification or qualification certification.

In one or more embodiments, the qualifications manager 318 is configured to link employees' proficiencies through the use of qualification certifications. In this case, qualification certifications may be defined as a set of training requirements for a person to become proficient in delivering a particular product or service. Further, qualification certifications may be used to determine different levels of proficiency for services provided by the user. Examples of levels of proficiency include, but are not limited to, basic level (i.e., the user is qualified with basic knowledge and/or is able to perform under supervision), intermediate level (i.e., the user is qualified to perform unsupervised), advanced level (i.e., the user is qualified to teach and/or train other users), and expert level (i.e., the user is qualified to do complex tasks or teach and/or train complex tasks).

In one or more embodiments, when a user enrolls for and completes the requirements for a qualification certification, the qualifications manager 318 is configured to record their progress and completion of the qualification certifications. For example, a user may be deemed competent to provide a particular service if the user has completed the following four items determined by the training manager 304: (1) attended and passed the relevant course; (2) completed a relevant examination; (3) completed relevant remote training; and (4) performed the service under supervision.

In one or more embodiments, the training monitor 320 is configured to interact with the curriculum manager 316 and the qualifications manager 318 to determine the users' training progress. Specifically, the training monitor 320 may obtain course information for users from the curriculum manager 316 and qualification information for users from the qualifications manager 318, and then use the information to determine the training progress of users.

In one or more embodiments, the qualifications monitor 322 is configured to interact with the qualifications manager 318 to determine the users' proficiency in specific services that the user is capable of providing. Specifically, the training monitor 320 may obtain qualification information for users from the qualifications manager 318, and then use the qualification information to determine the proficiency in particular services of the users.

In one or more embodiments, the user interface and reporting component 324 is configured to generate reports using the training monitor 320 and the proficiency monitor 322. For example, the user interface and reporting component 324 may be configured to generate detailed training requirements for each user with graphical and numerical indications of their progress using training information obtained from the training monitor 320. In another example, the user interface and reporting component 324 may be configured to generate reports for management and trainers showing individual status for all relevant users both in terms of competency and training progress using the training monitor 320 and proficiency monitor 322. In another example, the user interface and reporting component 324 may be configured to generate reports for management and trainers showing current training status of a particular group using the training monitor 320 (e.g., how many of this group have the qualification certification, or what is their average training progress).

In one or more embodiments, the user interface and reporting component 324 is configured to allow management and trainers to track the progress of users using the training monitor 320 and the proficiency monitor 322. Specifically, the user interface and reporting component 324 may be configured allow management to monitor the users' progress through training and approve training courses completed by the users. For example, the user interface and reporting component 324 may allow management to determine the services a user can provide (i.e., qualification certifications). In this example, management may use the qualification certifications of a user to make decisions related to service quality, resource management, and managing future training requirements for the user. In another example, the user interface and reporting component 324 may allow management to determine the availability of services by providing qualification certifications of users at a particular location or geomarket. In another example, the user interface and reporting component 324 may present completed training of a user to management for approval before a qualification certification may be granted to the user.

In one or more embodiments, the oilfield application 326 is configured to obtain training information from the training monitor 320 and qualification information from the proficiency monitor 322. The oilfield application 326 may correspond to a variety of applications (e.g., a modeling application, a risk assessment application, a well planning application, etc.) used to perform oilfield operations. For example, the oilfield application 326 may obtain proficiency and qualification information for a number of users located near a wellsite for use in generating a well plan for the wellsite.

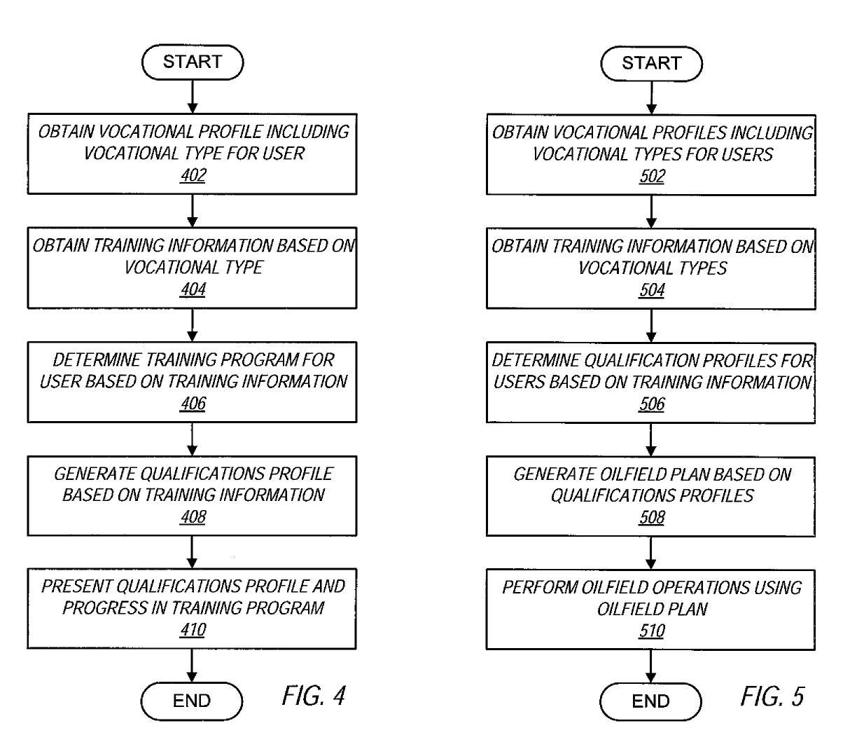

FIG. 4 shows a flow chart depicting a method for performing training as applied to oilfield operations. The method may be performed using, for example, the training system of FIG. 3. The method may involve obtaining a vocational profile for a user 402, obtaining training information using the vocational profile 404, determining a training program for the user based on the training information 406, generating a qualifications profile based on the training information 408, and presenting the qualifications profile 410.

A vocational profile may be obtained for a user 402. The vocational profile may include a vocational type specifying the vocation of the user. For example, the vocational type may specify that the user is a field engineer.

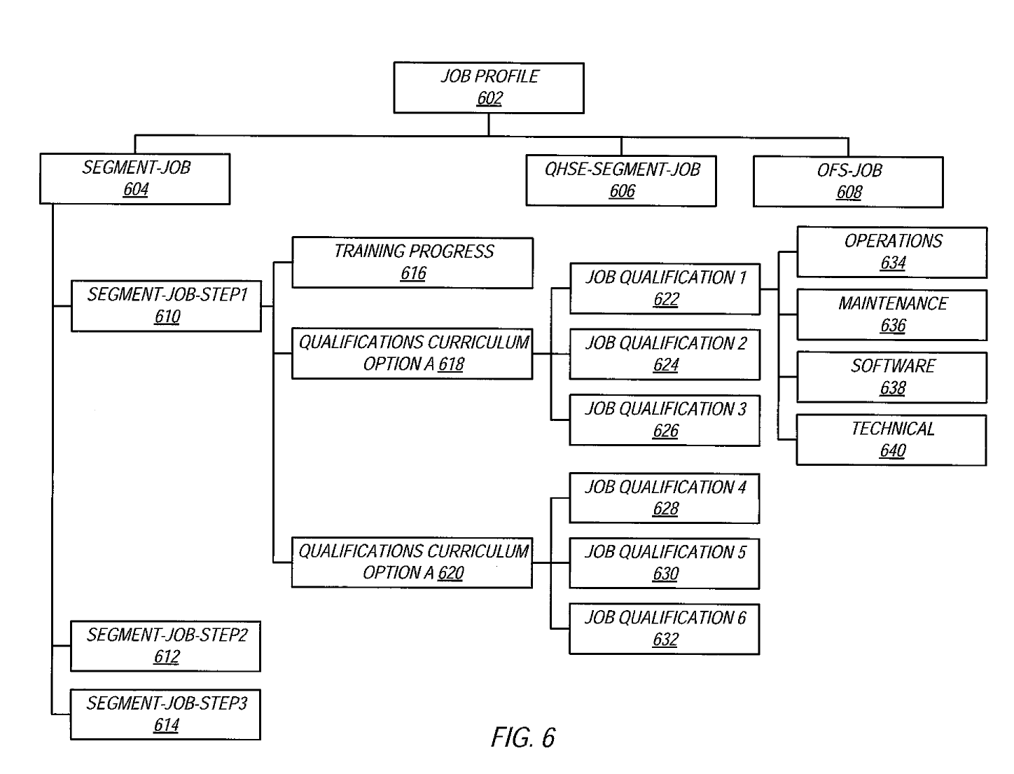

Next, training information may be obtained based on the vocational type 404. The training information may specify the training courses that the user is required to complete for the user's vocation. For example, the training information may specify a number of roles for the user, where each role is associated with training course(s) that the user must complete before being qualified for the role. In this case, a role may be related to qualification certification(s) as described above with respect to FIG. 3, and examples of roles and training course(s) are discussed below with respect to FIG. 6

At this stage, a training program may be determined for the user based on the training information 406. The training program may specify the training courses and order of completion required to achieve a corresponding role for the user. In this case, completion of a training course may result in a qualification certification being awarded to the user. Further, once the user has completed the appropriate number of qualification certifications, the user may be awarded a promotion certification for completing each of the required training courses and obtaining all of the corresponding qualification certifications.

A qualifications profile for the user may be generated based on the training information 408. The qualifications profile may specify the services and products that the user is qualified to provide. Further, the qualifications profile may also include the proficiency of each of the services that the user is capable of providing.

At this stage, the qualifications profile and the progress of the user in the training program may be presented to management for review 410. Management may use the qualifications profile and/or the progress of the user in the training program as described above with respect to FIG. 3. For example, the qualification profile may allow a user to examine the requirements for the user's next promotion (i.e., qualification certification and/or promotion certification). In this example, the requirements for a promotion may allow for flexibility for both the user and a manager who requires personnel with selected qualification profiles (e.g., qualified personnel for an upcoming operation).

The steps of the method in FIG. 4 are depicted in a specific order. However, it will be appreciated that the steps may be performed simultaneously or in a different order or sequence.

FIG. 5 shows a flow chart depicting a method for performing oilfield operations. The method may be performed using, for example, the training system of FIG. 3. The method may involve obtaining vocational profiles for a number of users 502, obtaining training information for the users using the vocational profiles 504, determining qualifications profiles for the users based on the training information 506, generating an oilfield plan based on the qualifications profiles 508, and performing the oilfield operations using the oilfield plan 510.

Vocational profiles may be obtained for a number of users 502. The vocational profiles may include a vocational type specifying the vocation of each of the users.

Next, training information may be obtained based on the vocational types of the users 504. The training information may specify the training courses that the users are required to complete for each of the user's vocation.

Qualifications profiles for the users may be generated based on the training information 506. The qualifications profiles may specify the services and products that each of the users is qualified to provide. Further, the qualifications profile may also include the proficiency of each of the services provided by each user.

At this stage, an oilfield plan is generated based on the qualifications profiles of the users 508. Specifically, the oilfield plan may describe how to perform oilfield operations, where the qualifications profiles are used to determine which users should provide specific services and/or products in the oilfield operations. In other words, the qualifications profiles may allow qualified employees to be assigned to operations and/or qualifications gaps that may prevent the company from performing operations in a given geographical area with the personnel currently available to be monitored and addressed. The oilfield operations may then be performed using the oilfield plan 510. For example, oilfield operations may be performed at a wellsite as described above with respect to FIGS. 1.1-1.4 and 2.

Those skilled in the art will appreciate that the steps of the method in FIG. 5 may be performed to similarly manage business operations. In other words, the method steps may be used to conduct business planning in any industry where a qualifications-driven training and work environment is used to generate training profiles and/or qualification profiles for employees. In this case, the qualifications profiles may be used to determine the operations that each of the users is trained to perform. In this example, the users may be specific to a particular project, associated with a geographic region, and/or associated with a department (i.e., group) of the company. Examples of business operations include, but are not limited to, construction, software development, emergency response, scientific research, oilfield operations, or any other operation requiring the management of employees with diverse training and/or qualifications.

The steps of the method in FIG. 5 are depicted in a specific order. However, it will be appreciated that the steps may be performed simultaneously or in a different order or sequence.

FIG. 6 shows an example job profile 602 in accordance with one or more embodiments. Specifically, the example job profile 602 shown includes three job roles (Segment Operations Role 604, Functional Role 606, Common Role 608). The example of FIG. 6 has been simplified to aid in the understanding of the invention and, as such, the invention should not be limited to the example.

In this example, the Segment Operations Role 604 of the Job Profile 602 includes a certification for each step (Segment-Job-Step1 610, Segment-Job-Step2 612, Segment-Job-Step3 614) of a fixed-step training program. In one or more embodiments, the fixed-step training program typically includes three steps and exceptionally up to five steps. However, those skilled in the art will appreciation that there is no limit to the number of steps within in a fixed-step training program. Each fixed-step training certification (e.g., Segment-Job-Step1 610, Segment-Job-Step2 612, Segment-Job-Step3 614) may contain all the training requirements for progressing to the next grade of the corresponding role.

More specifically, the Segment Operations Role 604 for each job profile 602 includes a single promotion certification (Segment-Job-Step1 610, Segment-Job-Step2 612, Segment-Job-Step3 614) for each grade of the fixed-step training program. For example, Table 1 below shows the fixed-step grades, and step certifications, associated with a junior field engineer, a field engineer, a junior field specialist, and a field specialist.

TABLE 1

| | SAP Job Type | | | |
|---|---|---|---|---|
| | Engineer | | Specialist | |
| | Trainee | Engineer | Trainee | Specialist |
| Role | Segment-Field | Segment-Field | Segment-Field | Segment-Field |
| Name | Engineer | Engineer | Specialist | Specialist |
| | Trainee | | Trainee | |
| Step | Grade 8-9 = | Grade 9-10 = | Grade 7-8 = | Grade 8-9 = |
| Certifi- | step 1 | step 2 | step 1 | step 2 |
| cations | | Grade 10-11 = | | Grade 9-10 |
| | | step 3 | | step 3 |
| Certifi- | Segment-JFE- | Segment-FE- | Segment-JFS- | Segment-FS- |
| cation | Step 1 | Step 2 | Step 1 | Step 2 |
| Name | | Segment-FE- | | Segment-FS- |
| | | Step 3 | | Step 3 |

Table 1 shows an example of a four promotion level, three step fixed-step training program. In this example, the fixed-step training program is shown without any sub-segment differentiation. If the training programs are completely different for each sub segment, a different set of promotion step certifications for each sub segment may be required. The set of promotion step certifications may be placed either under separate sub segment operations roles or as alternatives under a single role for the segment.

In the case of separate sub segment roles, the set of promotional step certifications may be defined by the segment job or by the segment and a specific sub segment job code. For example, the set of promotional step certifications may be defined by the job segments Well Test Type-Field Engineer Well Seismic Tool and Well Test Type-Fluid Analysis Engineer.

In one or more embodiments, each step certification (Segment-Job-Step 1 610, Segment-Job-Step2 612, Segment-Job-Step3 614) includes a Training Progress 616 and at least qualifications curriculum (Qualifications Curriculum Option A 618, Qualifications Curriculum Option B 620). The Training Progress 616 tracks training progress and validates completion of the fixed-stepped training program. Each qualification curriculum may be a predefined list of qualification certifications (e.g., Job Qualification 1 622, Job Qualification 2 624, Job Qualification 3 626). In this case, qualifications may refer to a service, answer product, or an essential area of work related to a business segment.

In this example, an employee within the Segment-Job 604 has two different training paths (Qualifications Curriculum Option A 618, Qualifications Curriculum Option B 620) to progress to the next promotion level. In this case, the creation within a segment role of two separate step certifications of the same level may not be permitted (e.g., under the Role AL-Field Engineer both AL-Field Engineer Step 1 and AL-Field Engineer Step 1a may not be permitted). Further, it may also not be permitted to construct multiple paths directly under the step certification (i.e., multiple paths should be constructed within the Training Progress 616 and the training paths).

The Training Progress 616 may track multiple training items (not shown). Example training items include, but are not limited to, pre-school curriculum, pre-school manager review, technical school attendances, post-school curriculum, post-school manager review, and manager review. Each of the training paths (Qualifications Curriculum Option A 618, Qualifications Curriculum Option B 620) may include qualification certifications (e.g., Job Qualification 1 622, Job Qualification 2 624, Job Qualification 3 626) as described above. Typically, each training path includes six or less qualification certifications. In this case, all or a subset of the qualifications may be required to complete each of the training paths (e.g., six qualifications certifications may be listed where any four are required to complete the training path).

In this example, each qualification certifications (e.g., Job Qualification 1 622, Job Qualification 2 624, Job Qualification 3 626) demonstrates knowledge and ability to provide a particular or general service, maintain a class of equipment, or similar competency to a certain proficiency level (e.g., run a basic well test, or a design using a particular technique in the case of research, engineering, manufacturing and sustaining). In this case, obtaining a qualification certification is required to demonstrate each proficiency level. The qualification certifications (e.g., Job Qualification 1 622, Job Qualification 2 624, Job Qualification 3 626) are normally job specific and coded as a Segment-Job 604 qualification. However, in one or more embodiments, the qualification certification may be applicable to more than one job.

In one or more embodiments, qualification certifications (e.g., Job Qualification 1 622, Job Qualification 2 624, Job Qualification 3 626) may be a validated set of learning objects and/or certifications that are required for an employee to perform a specific service or provide an answer product. Upon acquiring a qualification certification (e.g., Job Qualification 1 622, Job Qualification 2 624, Job Qualification 3 626), the employee may be qualified to deliver the specific service or answer product at one of the four proficiency levels described below in Table 2.

TABLE 2

| | Proficiency | |
|---|---|---|
| Qualifications | Level | Definition |
| Service or Answer Product | Basic | Qualified with Basic |
| Basic | | Knowledge |
| | | Qualified to perform under |
| | | supervision |
| Service or Answer Product | Intermediate | Qualified to perform |
| Service or Answer Product | | unsupervised |
| Intermediate | | |
| Service or Answer Product | Advanced | Qualified to teach/train others |
| Advanced | | |
| Service or Answer Product | Expert | Qualified to do complex task |
| Expert | | Qualified to teach/train |
| | | complex task |

A separate qualification certification (e.g., Job Qualification 1 622, Job Qualification 2 624, Job Qualification 3 626) may be created for each proficiency level that is to be tracked. In this case, for fixed step training, the job segment may only track intermediate proficiency so that only one qualification certificate (e.g., Job Qualification 1 622, Job Qualification 2 624, Job Qualification 3 626) is required per service. Those skilled in the art will appreciate that training may be offered in training programs by a variety of methods. The training products may correspond to learning objects, where the delivery type is typically web-based training, computer-based training, e-learning, and/or on-the-job training.

Each qualification certification (e.g., Job Qualification 1 622, Job Qualification 2 624, Job Qualification 3 626) may have up to four modules: an Operations Module 634, a Maintenance Module 636, a Software Module 638, and a Technical Module 640. The modules that are used for a given qualification certification (e.g., Job Qualification 1 622, Job Qualification 2 624, Job Qualification 3 626) may depend on the type of competency to be tracked. The Operations Module 634 may contain learning items related to the execution of a particular service. The Maintenance Module 636 may contain learning items related to outside maintenance that was already covered in the operations module as part of performing the service. Further, the Maintenance Modules 636 may be linked to the Engineering Management Society organization.

The Software Module 638 may contain learning items related to the software for performing the service (e.g., operating software, answer products, etc.). The Software Modules 638 may be linked to the Petro-Technical-Engineer/Information Technology (“PTE/IT”) community. The Technical Module 640 may contain learning items related to a technical domain (e.g., Geology, Geophysics, etc.). The Technical Modules 640 may be linked to the Schlumberger Competency Management Initiative (“SCMI”) community. In one or more embodiments, the modules that are linked to the Engineering, Manufacturing and Sustaining (“EMS”) and SCMI community are generally used as an entry level (or above) training requirement to the training program.

In one or more embodiments, a qualification curriculum module (e.g., Segment-Job-Step1 610, Segment-Job-Step2 612, Segment-Job-Step3 614) may be designed so that the employee is required to complete specific qualification certifications and/or select from up to six optional qualification certifications. In this case, if the number of qualification certifications to be listed exceeds six, or the selection required is more complex, then separate certifications (e.g., Qualifications Curriculum Option A 618, Qualifications Curriculum Option B 620) may be created within the qualification curriculum module to hold each group of qualification certifications.

Embodiments of business driven training and qualifications (or portions thereof), may be implemented on virtually any type of computer regardless of the platform being used. For example, as shown in FIG. 7, a computer system 700 includes one or more processor(s) 702 such as an integrated circuit, central processing unit (CPU), or other hardware processor, associated memory 704 (e.g., random access memory (RAM), cache memory, flash memory, etc.), a storage device 706 (e.g., a hard disk, an optical drive such as a compact disk drive or digital video disk (DVD) drive, a flash memory stick, etc.), and numerous other elements and functionalities typical of today's computers (not shown). The computer system 700 may also include input means, such as a keyboard 708, a mouse 710, or a microphone (not shown). Further, the computer system 700 may include output means, such as a monitor 712 (e.g., a liquid crystal display (LCD), a plasma display, or cathode ray tube (CRT) monitor). The computer system 700 may be connected to a network 714 (e.g., a local area network (LAN), a wide area network (WAN) such as the Internet, or any other similar type of network) with wired and/or wireless segments via a network interface connection (not shown). Those skilled in the art will appreciate that many different types of computer systems exist, and the aforementioned input and output means may take other forms. Generally speaking, the computer system 700 includes at least the minimal processing, input, and/or output means necessary to practice one or more particular embodiments of business driven training and qualifications (or portions thereof).

Further, those skilled in the art will appreciate that one or more elements of the aforementioned computer system 700 may be located at a remote location and connected to the other elements over a network. Further, one or more embodiments may be implemented on a distributed system having a plurality of nodes, where each portion may be located on a different node within the distributed system. In one or more embodiments, the node corresponds to a computer system. Alternatively, the node may correspond to a processor with associated physical memory. The node may alternatively correspond to a processor with shared memory and/or resources. Further, software instructions for performing one or more embodiments of business driven training and qualifications may be stored on a non-transitory computer readable storage medium such as a compact disc (CD), a diskette, a tape, or any other computer readable storage device.

It will be understood from the foregoing description that various modifications and changes may be made in the preferred and alternative embodiments of business driven training and qualifications without departing from its true spirit. For example, the method may be performed in a different sequence, and the components provided may be integrated or separate. The method may be applied to any business or operation where qualification-driven training is required or desired.

This description is intended for purposes of illustration only and should not be construed in a limiting sense. The scope of business driven training and qualifications should be determined only by the language of the claims that follow. The term “comprising” within the claims is intended to mean “including at least” such that the recited listing of elements in a claim are an open group. “A,” “an” and other singular terms are intended to include the plural forms thereof unless specifically excluded.

While business driven training and qualifications has been described with respect to a limited number of embodiments, those skilled in the art, having benefit of this disclosure, will appreciate that other embodiments can be devised which do not depart from the scope of business driven training and qualifications as disclosed herein. Accordingly, the scope of business driven training and qualifications should be limited only by the attached claims.

What is claimed is:

1. A method for business driven training, comprising:
obtaining a vocational profile for a user, wherein the vocational profile comprises a vocational type for the user;
obtaining training information for the user using the vocational type, wherein the training information comprises assessments and completed training of the user;
determining a training program for the user based on the training information, wherein the training program specifies required training courses to obtain a promotion certification for the user;
generating a qualifications profile based on the training information, wherein the qualification profile specifies services that the user is capable of providing; and
displaying the qualifications profile and a progress of the user in the training program, wherein the qualification profile comprises a proficiency for each of the services that the user is capable of providing.

2. The method of claim 1, further comprising:
obtaining a plurality of vocational profiles, wherein each of the plurality of vocational profiles comprises the vocational type for one of a plurality of users;
obtaining a plurality of training information using the vocational type, wherein each of the plurality of training information comprises the assessments and completed training of the one of the plurality of users; and
determining a plurality of qualifications profiles based on the plurality of training information, wherein each of the plurality of qualification profiles specifies the services that the one of the plurality of users is capable of providing.

3. The method of claim 2, further comprising:
selecting qualified personnel from the user and the plurality of users to perform a field operation, wherein selecting the qualified personnel is based on the services specified in the qualification profile and the plurality of qualification profiles that the qualified personnel are capable of providing.

4. The method of claim 1, wherein the promotion certification comprises a plurality of qualification certifications, wherein each of the plurality of qualification certification specifies that the user is capable of providing at least one of the services.

5. The method of claim 4, wherein the user completes a subset of the plurality of qualification certifications prior to obtaining the promotion certification.

6. The method of claim 1, wherein at least one of the required training courses is a web-based training course, wherein completion of the web-based training course is monitored to verify that the user obtains a qualification certification specifying that the user is capable of providing at least one of the services.

7. The method of claim 1, further comprising:
monitoring the progress of the user in the training program;
in response to determining that the user has completed one of the required training courses, obtaining approval from a manager of the user to grant a qualification certification to the user, wherein the qualification certification specifies that the user is capable of providing at least one of the services.

8. A system for business driven training, comprising:
a memory and a processor operatively connected to the memory;
a vocational profile data source configured to store a vocational profile for a user, wherein the vocational profile comprises a vocational type for the user;
a training manager executing on the processor and configured to provide training information for the user using the vocational type, wherein the training information comprises assessments and completed training of the user;
a curriculum manager executing on the processor and configured to determine a training program for the user based on the training information, wherein the training program is configured to obtain a promotion certification for the user;
a qualifications manager executing on the processor and configured to generate a qualifications profile based on the training information, wherein the qualification profile specifies services that the user is capable of providing; and
a field application executing on the processor and configured to select the user as a qualified person for performing a field operation based on the services that the user is capable of providing.

9. The system of claim 8, wherein:
the vocation profile data source is further configured to obtain a plurality of vocational profiles, wherein each of the plurality of vocational profiles comprises the vocational type for one of a plurality of users;
the training manager is further configured to obtain a plurality of training information using the vocational type, wherein each of the plurality of training information comprises the assessments and completed training of the one of the plurality of users; and
the qualifications manager is further configured to determine a plurality of qualifications profiles based on the plurality of training information, wherein each of the plurality of qualification profiles specifies the services that the one of the plurality of users is capable of providing.

10. The system of claim 8, wherein the promotion certification comprises a plurality of qualification certifications, wherein each of the plurality of qualification certification specifies that the user is capable of providing at least one of the services.

11. The system of claim 10, wherein the user completes a subset of the plurality of qualification certifications prior to obtaining the promotion certification.

12. The system of claim 8, wherein at least one of the required training courses is a web-based training course, wherein completion of the web-based training course is monitored to verify that the user obtains a qualification certification specifying that the user is capable of providing at least one of the services.

13. The system of claim 8, further comprises:
a user interface and reporting component configured to, in response to determining that the user has completed one of the required training courses, obtain approval from a manager of the user for granting a qualification certification to the user, wherein the qualification certification specifies that the user is capable of providing at least one of the services; and
wherein the training manager is further configured to monitor a progress of the user in the training program.

14. A computer readable storage medium storing instructions for performing business operations, the instructions when executed causing a processor to:
obtain a plurality of vocational profiles, wherein each of the plurality of vocational profiles comprises a vocational type for one of a plurality of users;
obtain a plurality of training information using the vocational type, wherein each of the plurality of training information comprises assessments and completed training of the one of the plurality of users;
determine a plurality of qualifications profiles based on the plurality of training information, wherein each of the plurality of qualification profiles specifies services that the one of the plurality of users is capable of providing; and
select qualified personnel from the plurality of users to perform a field operation based on the services that the one of the plurality of users is capable of providing.

15. The computer readable storage medium of claim 14, the instructions when executed further causing the processor to:
determine a training program for each of the plurality of users based on one of the plurality of training information, wherein the training program specifies required training courses for the each of the plurality of users to obtain a promotion certification

16. The computer readable storage medium of claim 15, wherein the promotion certification comprises a plurality of qualification certifications, wherein each of the plurality of qualification certification specifies that the each of the plurality of users is capable of providing at least one of the services.

17. The computer readable storage medium of claim 16, wherein the each of the plurality of users completes a subset of the plurality of qualification certifications prior to obtaining the promotion certification.

18. The computer readable storage medium of claim 17, wherein at least one of the required training courses is a web-based training course, wherein completion of the web-based training course is monitored to verify that the each of the plurality of users obtains a qualification certification specifying that the each of the plurality of users is capable of providing at least one of the services.

19. The computer readable storage medium of claim 14, the instructions when executed further causing the processor to:
monitor availability of the plurality of users in a geographical area of the field operation to identify a qualification gap preventing the field operation from being performed.

20. The computer readable storage medium of claim 14, the instructions when executed further causing the processor to:
monitor a progress of each of the plurality of users in the training program;
in response to determining that the each of the plurality of users has completed one of the required training courses, obtain approval from a manager of the each of the plurality of users to grant a qualification certification to the each of the plurality of users, wherein the qualification certification specifies that the each of the plurality of users is capable of providing at least one of the services.
